(19) United States
(12) Patent Application Publication
(10) Pub. No.: US 2018/0357701 A1
(43) Pub. Date: Dec. 13, 2018

(54) SYSTEM AND METHOD FOR PREDICTIVE RECREATIONAL CANNABIS STRAIN RECOMMENDATION

(71) Applicant: NC3 Systems, San Jose, CA (US)

(72) Inventors: Michael Viet Thang Vu, San Jose, CA (US); Larry Nelson Thacker, JR., San Juan Capistrano, CA (US); Sarah Rose Rothrock, San Francisco, CA (US); Dennis Robert O'Malley, San Carlos, CA (US); Steven Stubblefield, Encinitas, CA (US)

(21) Appl. No.: 15/616,886

(22) Filed: Jun. 7, 2017

(51) Int. Cl. G06Q 30/06; G06N 5/02

(52) U.S. Cl. CPC G06Q 30/0631; G06N 5/022

(57) ABSTRACT

A system for predictive recreational cannabis strain recommendation has been developed. Recreational cannabis clients enter a description of their desired cannabis mediated experience. This description is normalized and employed in conjunction with system transformed data assigning a plurality of physiological effects to a plurality of specific cannabis strains and available previous experience data to arrive at strain recommendations for strains matching the client's experience request using predictive analytics functions engineered for the recreational cannabis trade.

### CROSS REFERENCE TO RELATED APPLICATIONS

None.

### BACKGROUND OF THE INVENTION

### Field of the Invention

The present invention is in the field computer system engineering in recreational cannabis commerce. Specifically, the use of an advanced predictive decision system to match new recreational cannabis users to strains that provide desired effects and to allow experienced users to determine strains that produce unexperienced effects of interest to them.

### Discussion of the State of the Art

Recently, multiple states have passed legislation legalizing cannabis for recreational usage. This change promises to greatly change the cannabis usage landscape as significant numbers of people use cannabis for the first time and those with prior cannabis experience find that the number and variety of cannabis strains, which include the range and subtlety of effects, may greatly increase over that available to them before and these experienced users determine that they may want to take advantage of these changes to expand their range of experience with cannabis to discover favorites for different moods and circumstances or to “spice things up” on occasion.

What is needed is a system to predictively assist both first time and experienced recreational cannabis users in the selection of cannabis strains most likely to provide a desired set of effects accounting for current perceived status and any previous reported experience with known cannabis strains and route of consumption.

### SUMMARY OF THE INVENTION

Accordingly, the inventor has developed a system and method for predictive recreational cannabis strain recommendation comprising centralized servers and data stores that retrieve and process such data as, but not limited to, scientific analysis results from cannabis strain and strain material source study of active compound ratios and levels, the latest findings on cannabis active compound effects and cannabis user reviews and reported effect potency data for specific strains and material from specific cannabis sources. These data as well as data that may not have been mentioned are then employed to predict suitable cannabis strain and delivery route recommendations for both recreational users new to cannabis, who may have little or no experience with the many strains and possible effects or mixes of effects, and experienced users who may have significant experience with a limited number of strains of cannabis but want to expand their knowledge, possibly fine tuning one or more desirable effects they have had or looking for new effect driven experiences. In both cases, the customer may enter one or more standardized effects that they desire and the system then may recommend one or more strains, possible legal cannabis sources of known quality and potency for the recommendations, and route of delivery that is expected to produce those effects, the embodiment also taking into account any previous cannabis experience or general medical drug sensitivity levels that the customer may have entered during account setup and embodiment usage representing multiple cannabis experiences. Customers are encouraged to keep a “diary” of their strain usage, delivery method and subjective reactions to the effects of each strain tried to better recommendation accuracy over time and more generally across the embodiment which employs artificial intelligence algorithms and learning in the classification of strain specific effects and user's response to them.

According to a preferred embodiment of the invention, a system predictive recreational cannabis strain recommendation comprising: an input portal stored in a memory of and operating on a processor of a computing device and configured to: receive cannabis use experience feedback from clients and normalize at least a portion of that data for predictive analytics computation; retrieve the results of scientifically controlled cannabis strain analysis and normalize at least a portion of that data for predictive analytics computation; and receive requests comprising at least one effect desired by the client for a future cannabis experience and normalize at least a portion of that data for predictive analytics computation; and an experience analytics module stored in a memory of and operating on a processor of a computing device and configured to: retrieve normalized client supplied cannabis use experience feedback data; retrieve normalized scientifically controlled cannabis strain analysis data; receive normalized request comprising at least one cannabis effect desired by the client for a future cannabis experience; retrieve normalized data that attributes physiological effects to known active cannabis resident compounds; programmatically calculate effect rating scores for cannabis strains based at least in part upon the analysis determined active cannabis resident compound levels and known effects of active cannabis resident compounds; programmatically determine at least one cannabis strain from at least one legal cannabis source that closely matches client's normalized request and accounts for at least the client's previous use experience feedback data using predictive inference functions engineered for recreational cannabis trade; and a recommended product choices display stored in a memory of and operating on a processor of a computing device and configured to: output at least one recommended recreational cannabis strain that closely matches clients' normalized requests in a format best suited for this task.

According to a preferred embodiment of the invention, a method for predictive recreational cannabis strain recommendation comprising the steps of: a) receiving cannabis use experience feedback from clients and normalizing at least a portion of that data for predictive analytic computation using an input portal stored in a memory of and operating on a processor of a computing device; b) retrieving the results of scientifically controlled cannabis strain analysis and normalizing at least a portion of that data for predictive analytics computation using the input portal; c) receiving requests comprising at least one effect desired by the client for a future cannabis experience and normalize at least a portion of that data for predictive analytics computation using the input portal; d) retrieving normalized data that assigns physiological effects to known active cannabis resident compounds using an experience analytics module stored in a memory of and operating on a processor of a computing device; e) calculating effect rating scores for cannabis strains based at least in part upon the analysis determined active cannabis resident compound levels and at least in part upon known effects of active cannabis resident compounds using the experience analytics module; f) determining at least one cannabis strain from at least one legal cannabis source that closely matches client's normalized request and accounts for at least the client's previous use experience feedback data employing predictive inference functions engineered for recreational cannabis trade using the experience analytics module; g) outputting at least one recommended recreational cannabis strain that closely matches clients' normalized requests in a format best suited to convey this information using a recommended product choices display stored in a memory of and operating on a processor of a computing device.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a diagram of an exemplary architecture of predictive recreational cannabis recommendation system according to an embodiment.

FIG. 2 is a method flow diagram of an exemplary generalized function of a predictive recreational cannabis recommendation system according to an embodiment.

FIG. 3 illustrates the analytical active compound make-up of multiple hypothetical cannabis strains used by an embodiment.

FIG. 4 is a diagram illustrating the a method to classify cannabis strains based upon the active compound constituent levels according to an aspect of the invention.

FIG. 5 is a flow diagram illustrating how chemo-analysis data may be used as part of a customer targeted cannabis strain recommendation according to embodiments.

FIG. 6 is a block diagram illustrating exemplary interactions of multiple client devices with outward facing aspects of the predictive recreational cannabis recommendation system, according to various embodiments.

FIG. 7 is a simplified screen capture of a recreational customer cannabis choice input screen according to embodiments.

FIG. 8 is a second simplified screen capture of a recreational client cannabis choice input screen various embodiments of the invention.

FIG. 9 is a flow diagram of steps taken by an aspect of the invention to convert a client's input into a cannabis strain and mode of delivery recommendations.

FIG. 10 is a diagram illustrating the use of routing regulatory labels to create availability zones.

FIG. 11 is a block diagram illustrating an exemplary hardware architecture of a computing device used in various embodiments of the invention.

FIG. 12 is a block diagram illustrating an exemplary logical architecture for a client device, according to various embodiments.

FIG. 13 is a block diagram illustrating an exemplary architectural arrangement of clients, servers, and external services, according to various embodiments.

### DETAILED DESCRIPTION

While strictly illegal in all states until recently, cannabis, more commonly known as marijuana since the mid-1930's, has been extensively cultivated throughout the world for centuries and secretly cultivated within the United States and elsewhere where the plant and its products are illegal to the point where there are tens if not hundreds of cultivars or strains which comprise differing levels of the many active compounds that give cannabis its wide range of sought after effects. A family of active compounds that are specific to cannabis and its close relative plant species is the cannabinoids of which nearly 70 have been identified that have overlapping but different effect profiles. Perhaps best known and present at high but varying concentration in cannabis strains are delta-9-tetrahydrocannabinol (THC) which can vary from approximately 27% to as low as 0.1% (wt/total isolate wt. Steep Hill Labs/steephill.com) depending on the cannabis strain and which is the psychoactive agent responsible for cannabis' ability to alter mood, to give the impression of altered consciousness and to cause feelings of euphoria which people consider the “cannabis high.” Another cannabinoid, cannabidiol (CBD) can vary depending on the strain from approximately 30% to as low as 0.02% and to which the calming, contentment, “stoned feeling” effects of certain cannabis strains is attributed. A third major cannabinoid, cannabinol (CBN) is found in stored, dried cannabis and may also be a thermal breakdown product of THC. CBN is therefore usually found in higher concentrations in smoke or vaporization delivery methods. It is strongly sedative and again may add the “stoned”, inactive, reputation of some cannabis users. A second family of active compounds, the terpenes, are a very large family of aromatic branched hydrocarbons that are produced by a wide variety of plant species and are among the active ingredients of essential oils created from them. Different cannabis strains produce widely different terpenes and their derivative terpenoids at widely different levels that may range from 0% to 5% wt/wt and which may give different cannabis strains their unique odors. Terpene's impact on recreational cannabis effects include potentiating the effects of specific cannabinoids such as THC and having weak sedative, anti-anxiety and pain-reducing properties of their own.

It is the differences in the levels and types of both cannabinoids and terpenes as well as the presence of lesser compounds such as flavonoids that impart cannabis strains with a wide range of recreationally desirable effects that the aspects of the invention described herein employs to match the desired experience of clients with known strains.

The inventor has conceived, and reduced to practice, a system and method for predictive recreational cannabis strain recommendation.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring sequentially (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself

Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

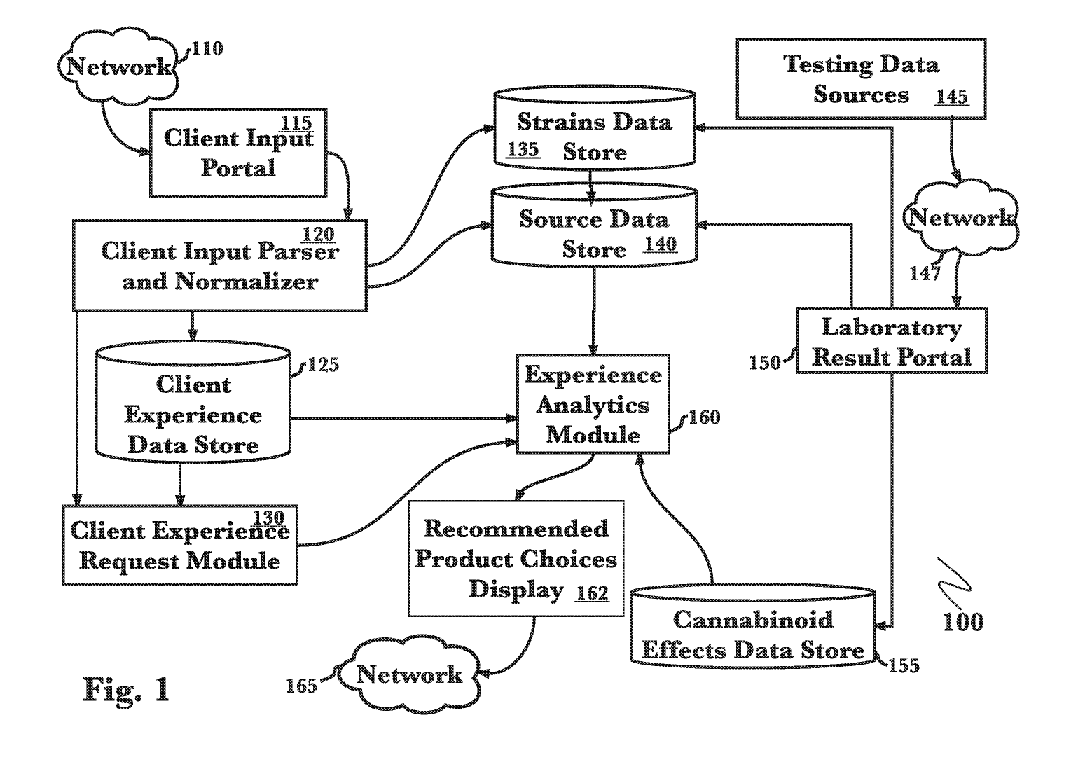

FIG. 1 is a diagram of an exemplary architecture of predictive recreational cannabis recommendation system according to an embodiment 100. In the illustrated embodiment, all client requests and information may enter the embodiment 100 through a client input portal 115 and may be mediated by a network connection such as but not limited to a secure internet connection or over a private WAN or LAN 110 depending on the relationship of the client to the embodiment 100. A portion of this incoming client interaction may be limited, known response data to canned questions posed by the embodiment such as but not limited to pre-designated desired cannabis effects choices, method of delivery preferences, and certain initial state information an example of which may be whether a new client considers themselves more sensitive to medication than her peers, in addition to other questions posed so as to generate pre-designated return data. A significant amount of data is expected to be in the form of free flow text, such as but not limited to experience reviews, requests for information on the active compound make-up, known cumulative effects, and possible local legal retail sources of specific cannabis strains, and certain initial status information the answers for which cannot be pre-determined. Such information may be normalized and then parsed for meaningful keywords, key-phrases and contextual meaning, among other language markers used in parsing known to those skillful in the art, in the client input parser and normalizer 120. During the parsing process, the text may be transformed into terms standard to the embodiment and substituted for non-standard terms or phrases found in client freeform text. Client input identified as experience review data may be stored in the client experience data store 125 for use both during subsequent use of the embodiment by the same client to better tailor person cannabis recommendations. User previous experience data may also be employed, in a much more general manner, to train the embodiment and thus more finely affect general cannabis strain recommendations for all users through learned algorithm modifications. Some of the client review data may be stored in a strains data store 135 or a source data store 140 if a new subtlety of that strain's effects or changed effects of a standardized strain when obtained from a specific supplier is repeatedly reported. This will allow, among other uses, repetitive variations to be investigated and possibly incorporated into future recommendations of that strain and supplier 162. New client experience requests normalized, parsed and transformed into embodiment usable terms are interpreted by the client experience request module 130 which may compare the desired effect specifics of the request to the effects reported from previous experiences stored in the client experience data store 125 to find confirmed reports of certain strains from known sources that may aid in providing new clients with an experience closest to expectation.

This hint augmented data is passed to the experience analytics module 160 where it is combined with client generated strain 135 and source 140 data, active ingredient make-up data generated from a plurality of laboratory based cannabis strain analyses from multiple possible test centers 145 which may be retrieved by the laboratory result portal 150 using one of several possible network types 147. Some of this laboratory-generated data may pertain to determined effects of cannabinoids and other constituent compounds of cannabis strains. These data may be stored in a cannabinoid effects data store 155. The active compound make-up of a plurality of cannabis strains 135 from a plurality of suppliers 140, the effects each active compound, individually as well as when combined, in addition to available matching client experience reports 125 may be predictively analyzed using the software engineered functions of the experience analytics module 160 to calculate the strains and suppliers most likely to fulfill the experience request of the client. The recommendations may be displayed on that client's computing device by the recommended product choices display 162, possibly over a type of network connection 165.

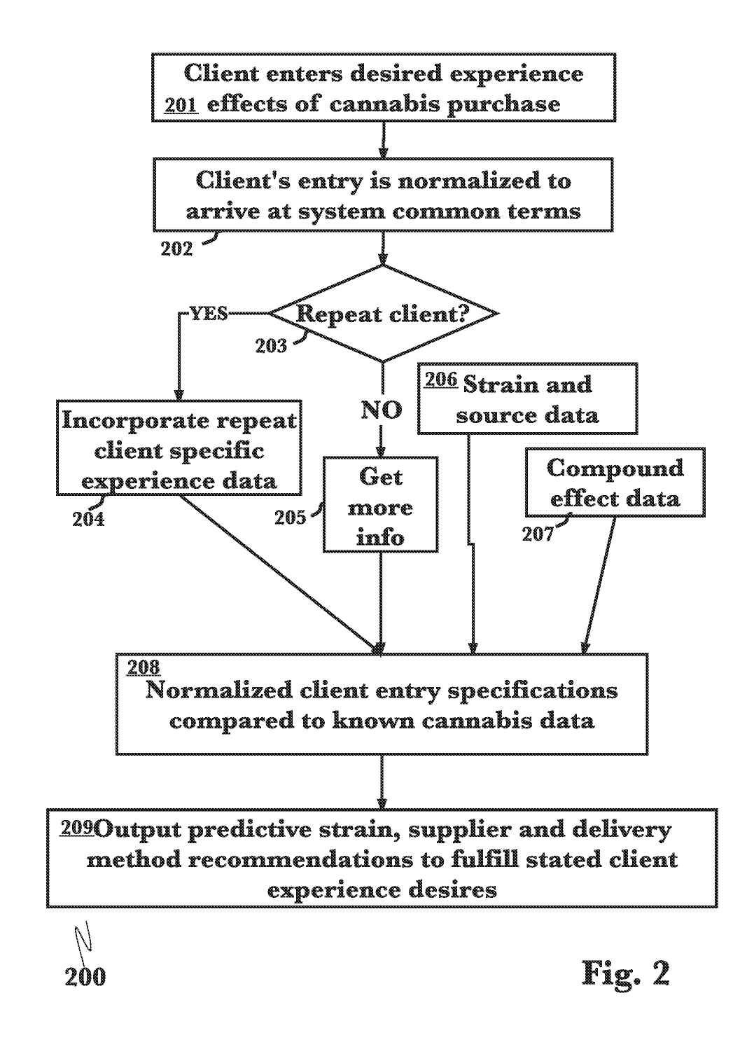

FIG. 2 is a method flow diagram of an exemplary generalized function of predictive recreational cannabis recommendation system according to an embodiment 200. The predictive recommendation process begins with a recreational cannabis customer choosing her desired end status from a list of descriptors which may span the gamut of possible cannabis effects from hyper-strong active high to a sedentary dreamlike state such as but not limited to “Hyper-Buzz”, “Energy”, “In Control”, “Giggles”, “Content”, “Major Chilled”, “No Cares” and “In a Dream” 201. Under some embodiments the client may be able to also enter freeform text modifiers to these provided experience choices (for example: “High from Agent Orange too severe, bad come down”) or other experience related instructions (for example: “I need a discrete delivery method.”) that then may be normalized, parsed and transformed into embodiment actionable terms 202. An aid to better tailoring a client experience may be to use the client's reviews of any past experiences with one or more cannabis strains to affect current predictive strain recommendations. If the client is a repeat embodiment customer 203, any previous specific experience, as entered into the embodiment, or level of general cannabis experience data may be used in formulating a current recommendation 204. If this is the first time a client is using the embodiment, general current life status questions such as, but not limited to, perceived general medication sensitivities (for example, “Allergy medications really knock me out”) and current mood (for example, “I am currently feeling down”) may be posed either as canned multiple-choice questions or as questions inviting freeform answer 205. The amount and specifics, if known, of the new client's cannabis experience may also be queried 205. As illustrated in FIG. 1, previously gathered and stored data specifying the active compound content of known strains 135 from specific suppliers 140, and the effects of each of these active compounds derived from scientific analysis 155 are programmatically used 206, 207 in conjunction with normalized client data 204, 205 to predict which cannabis strain or strains known to the embodiment may produce an experience closest to the client's request 208. This strain and supplier data, along with any recommended delivery method data which may include a delivery method requested by the client is then provided to the client 209.

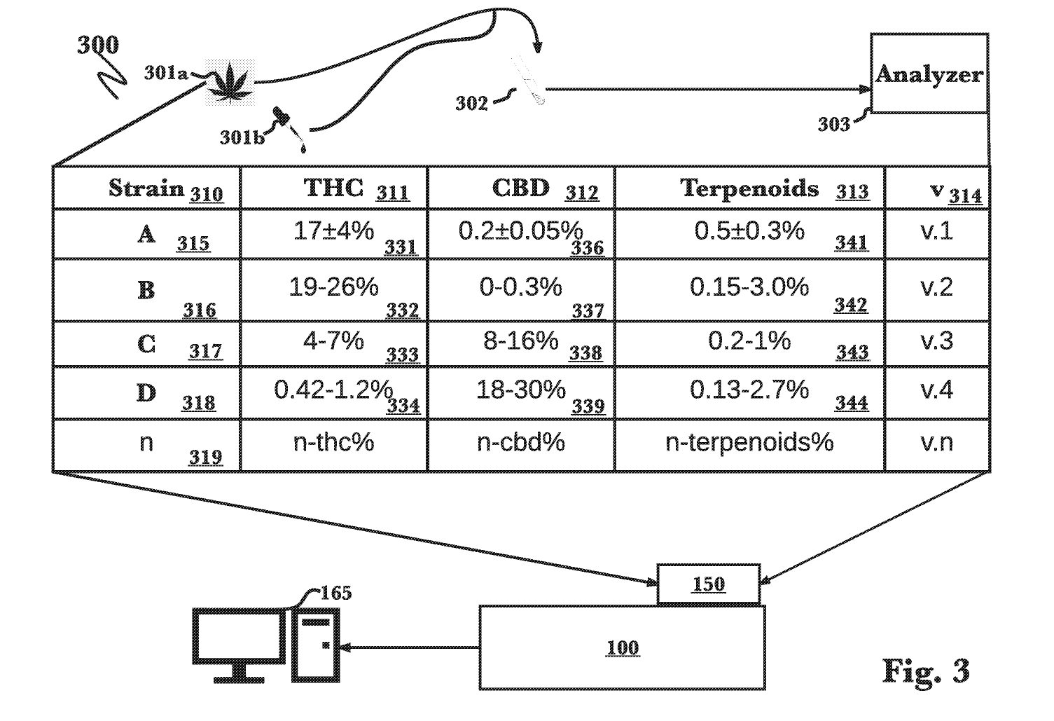

FIG. 3 illustrates the analytical active compound make-up of multiple hypothetical cannabis strains used by an embodiment 300. As previously mentioned, different cannabis strains may express different levels of the compounds that produce recreationally desirable effects. This may be illustrated using a table denoting a small number of the major active compounds and the amounts of each of the listed compounds expressed as percent weight compound/total weight extracted material (% wtₐ/wtₜ). It is known that the method of active compound delivery (examples: smoked dried buds 301a, vaporized buds 301a, kief, hash or tincture 301b) may greatly change active compound levels and ratios due to process mechanics. It is therefore important, if possible, to independently test samples 302 meant for these delivery methods separately if analysis accuracy 303 is a high priority goal. Listed are a plurality of hypothetical cannabis strains 310, 315, 316, 317, 318, 319 and active compounds that may be found in those cannabis strains 311, 312, 313, 314. All active compound levels are listed in percent wt_{compound}/wt_{totalExtract} some as mean±variance 331, 336, 341, others as ranges 332, 333, 334, 337, 338, 339, 341, 342, 343, 344. One can see that, as mentioned earlier, these levels may vary quite widely between strains. For example, for THC, the levels may vary from 26% 332 for strain “B” 316 to as low as 0.42% 334 for strain “D” 318 whereas the CBD levels vary from 30% 339 in strain “D” 318 to unmeasurable 337 in strain “B” 316. The terpenoids, which are a large family of related compounds, follow similar variability between strains. Embodiments are engineered to retrieve this analytical level data from testing sources 150 and since the levels of these active compounds, both total and comparative to each other, in these strains may be responsible for the recreational experience arising from each strain's use, that information used by the analytic programming of the embodiment 100 as part of the strain recommendation process delivered to clients 165. Please note that this figure is presented solely to effectively illustrate that large differences may exist between strains in the levels of cannabis active compounds. As the total level of a single active compound and the combination of the levels of two or more active compounds may affect the cannabis experience, illustration of a small number of compounds was necessary to make serval salient points. The small number of strains and compounds as well as the combination of all terpenoids into one column was to produce a clear basis for disclosure and does not in any way reflect the function of the embodiments.

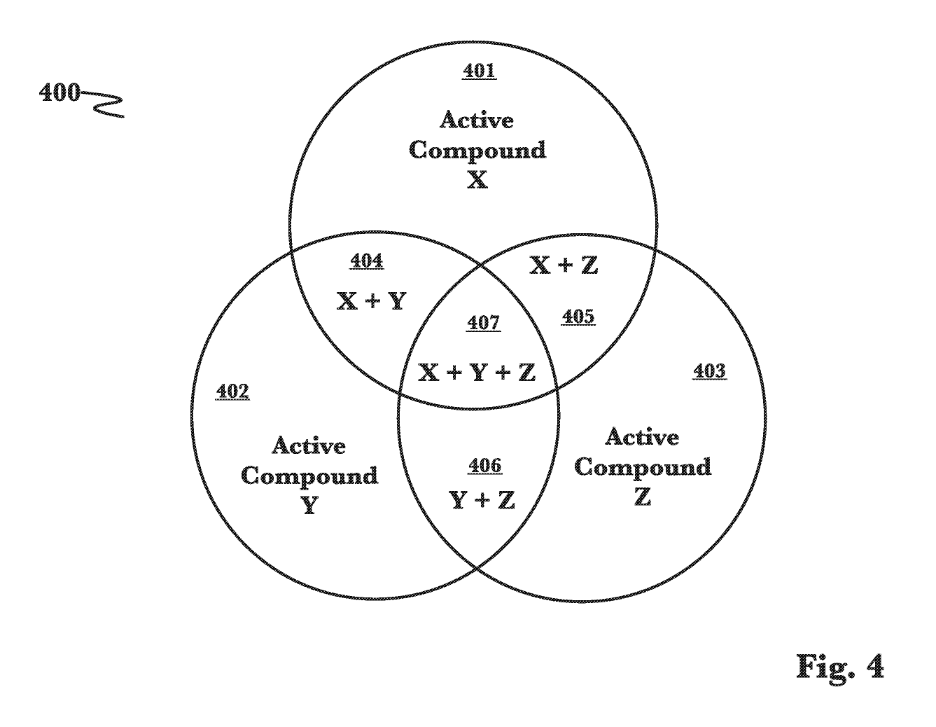

FIG. 4 is a diagram illustrating a method to classify cannabis strains based upon the active compound constituent levels according to an aspect of the invention 400. A way of simplistically visualizing a basic aim of the software programming of the embodiment regarding cannabis active compounds as they relate to cannabis experience, using only the most primary of parameter considerations, is through the use of a Venn diagram. Here are shown a set of three active compounds, X 401, Y 402, and Z 403 which for illustrative purposes may represent the cannabinoids THC (X) 401, CBD (Y) 402, and CBN (Z) 403. Further, the effects prediction functions of the embodiment may require that for inclusion in the set represented by 401, a cannabis strain must analytically contain (see FIG. 3) at least 15% THC, inclusion in 402 require a strain to analytically contain at least 10% CBD and inclusion in 403 require at least 0.1% CBN. Cannabis strains meeting only one of these three criteria may, for illustrative purposes, be categorized by the embodiment as providing only the three “primary” effects attributed to the indicated active compounds. The programming functions may then employ information such as, but not limited to, available scientific cannabis effects testing data, program function mediated predictive mixing of the known effects of constituent active compounds derived by the programming of the embodiment, and available generalized client experience reports to arrive at effect profiles for strains possessing at least the embodiment established active compound minimums. Thus, strains possessing both THC 401 and CBD 402 above programmatically established levels may form a fourth effects category, X+Y 404 with a predicted set of unique effects, strains possessing both THC 401 and CBN 403 above programmatically established levels may form a fifth effects category, X+Z 405 with a predicted fifth set of unique effects and strains possessing both CBD 402 and CBN 403 above programmatically established levels may form a sixth effects category, Y+Z 406 with a predicted sixth set of unique effects. Last, a seventh effects category may be formed by strains possessing at least the programmatically established minimal levels of all three active compounds 407 (THC 401, CBD 402, CBN 403) would be predictively assigned a seventh unique set of effects. Programmatically placing cannabis strains known to the embodiment that have been analyzed for levels (said levels may be expressed in a plurality of methods which are normalized by the embodiment) of at least a subset of the major active compounds known to be found in cannabis into categories, seven categories in this illustration, and then ascribing effects based at least based upon the scientifically known effects of each of those active compounds is an effective method of predictive cannabis recommendation. Other methods, such as but not limited to establishment of experience effect matrixes, which may allow the effect nuances of additional active compounds present, possibly at lesser levels, to be incorporated may be used by embodiments, among other formats allowing more efficient storage or effect gradation flexibility that may also be used. These examples are in no way presented the limit the abilities of the embodiments as an embodiment may employ any cannabis strain to recreational effect scoring system known to be available by those skilled in the art.

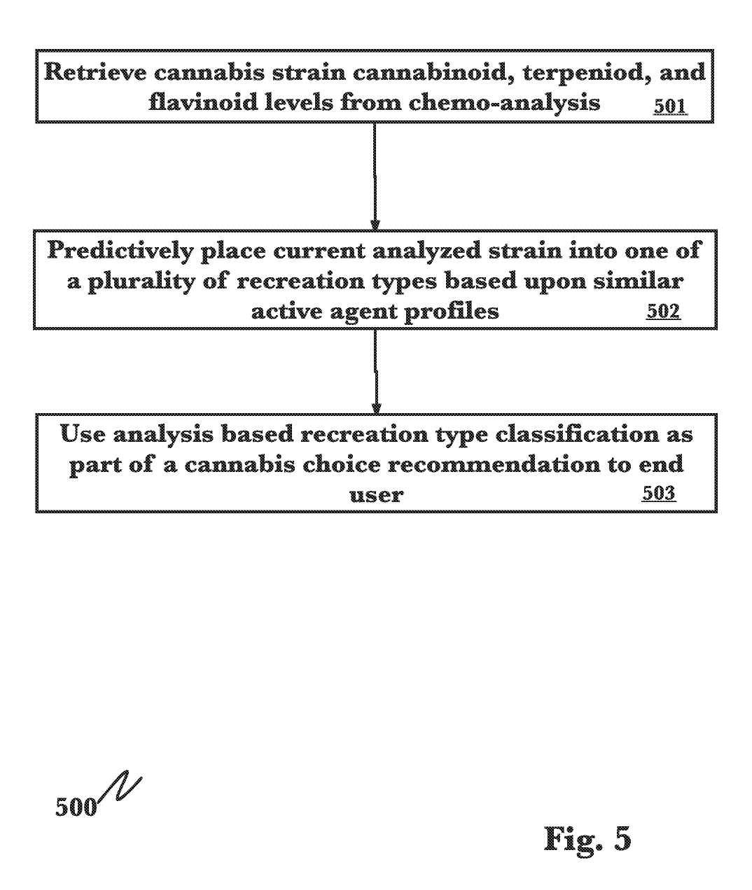

FIG. 5 is a flow diagram illustrating how chemo-analysis data may be used as part of a customer targeted cannabis strain recommendation system 500 according to embodiments. Part of the client cannabis recommendation process includes retrieving chemo-analysis results for at least a subset of active compounds of recreational experience importance, which may include cannabinoids, terpenes and flavonoids, from testing sources 501. Embodiments may then predictively categorize analyzed strains, programmatically categorizing them into a finite number of types of recreational value based upon active compound total levels and known composite effects of co-resident active ingredients 502 These categorized data may then be used in conjunction with effect nuances learned from client past experience reports concerning specific strains through the programming functions of the experience analytics module 160 to provide strain recommendations based on recreational use client's stated experience desires 503.

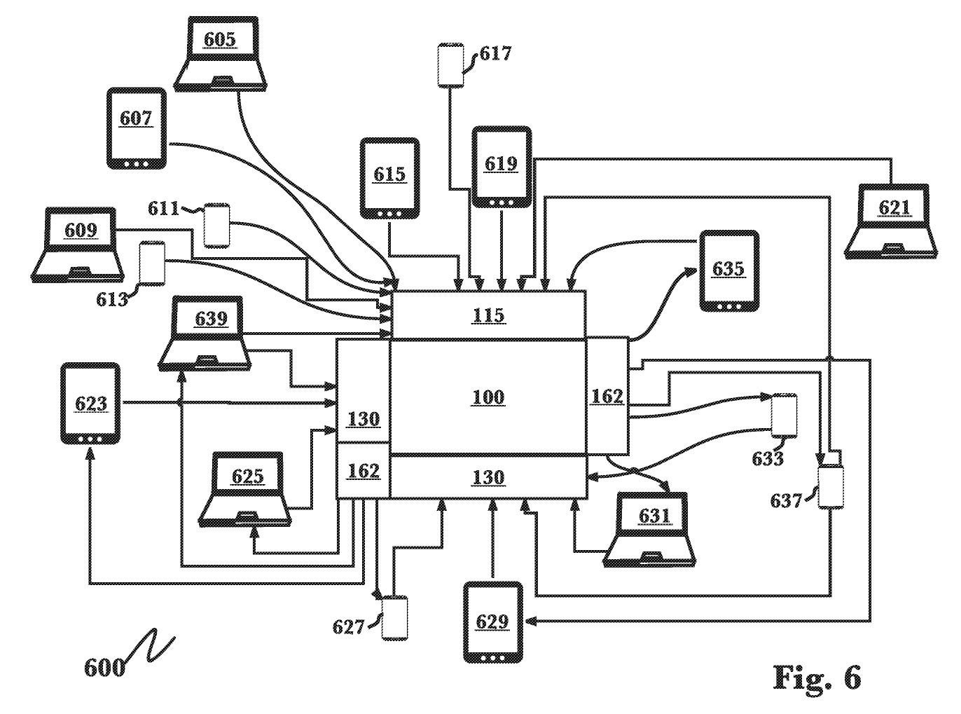

FIG. 6 is a block diagram illustrating exemplary interactions of multiple client devices with outward facing aspects of the predictive recreational cannabis recommendation system 100, according to various embodiments 600. Clients are envisioned to interact using various forms of computing device, such as but not limited to desktop or laptop workstation 605, 609, 621, 625, 631, 639, tablet 607, 615, 619, 623, 629, 635 and smartphone 611, 613, 617, 627, 633, 637 with the interaction channels of the embodiment 100 which include the client experience request module 130, the client input portal 115 and the recommended product choices display 162. Depending on their intent, some clients may interact at a given instant with the client input portal, 115, predominantly when entering reports from recent recreational cannabis experience into their data record 605, 607, 611, 615. Others 625, 627, 629, may interact first with the client experience request module 130 to request a specific set of experience effects for a future recreational cannabis usage and then receive cannabis strain recommendations which closely match the requested experience effects from the embodiment's recommended product choices display which also may contain a list of recommended suppliers that have cannabis that fulfills the request 162. Still other clients 637, 639 may interact with all three channels over a short period of time as they first enter information on previous cannabis experience using the client input portal 115, then submit a new experience request, possibly with significantly different desired effects using the client experience request module 130 and finally receive recommendations from the embodiment through the recommended product choices display 162.

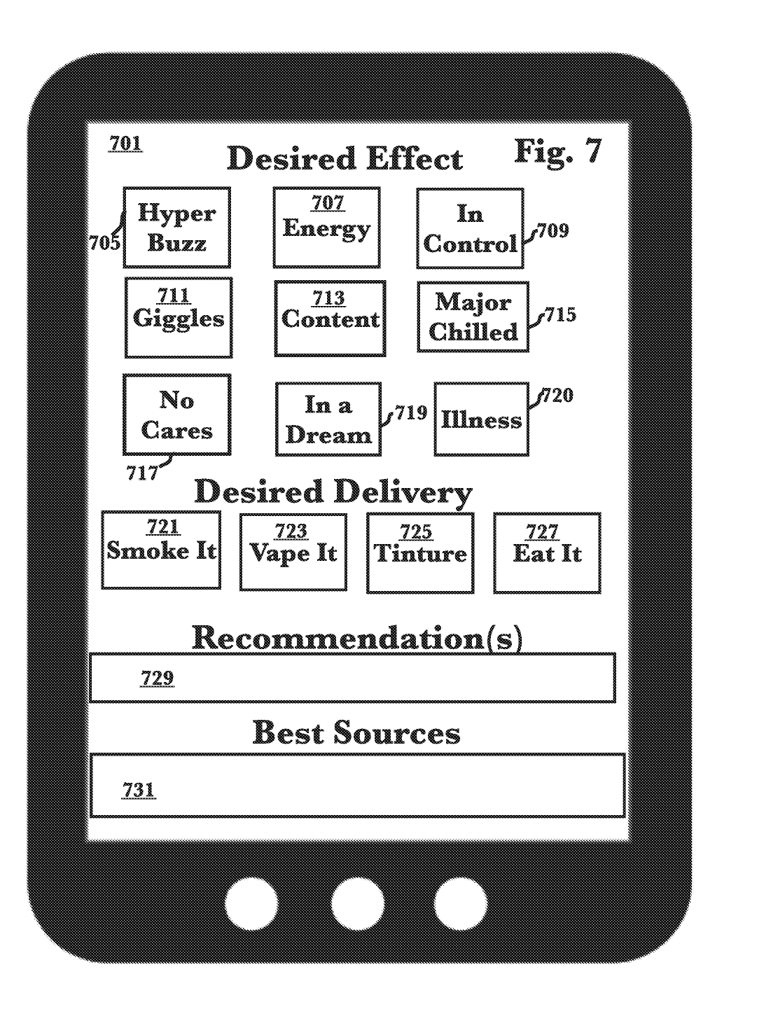

FIG. 7 is a simplified screen layout of a recreational customer cannabis choice input screen according to embodiments. A simplified initial experience request screen as presented on a tablet device 701 shows that for at least a plurality of embodiments, recreational experience types may be presented as a set of pre-designated choices ranging from a high energy, altered state, high THC content extreme to a highly content, highly easy going, possibly drowsy high CBD content extreme with states reflecting a mixture of the two and possible effects of other active compounds found in the plurality of analyzed cannabis strains in between. Here the choice labels given are “Hyper Buzz” 705, “Energy” 707, “In Control” 709, “Giggles” 711, “Content” 713, “Major Chilled” 715, “No cares” 717 and “In a dream” 719, each representing a grouping of cannabis strains producing similar effects. Also present are method of delivery choices that the client may choose such as smoking the cannabis buds 721, using a vaporizer to extract the active compounds and then inhaling the vapor 723, delivering extracted cannabis compounds in a tincture 725 or consuming the cannabis buds or the extracted active compounds by eating them in some form of prepared food or spread 727. Each of these delivery method choices may have a great effect on the selection of recommended cannabis strains and commodity supplier due to potential differential extraction of each active compound during processing to permit the varying delivery methods. Predictive recommendations that closely match the client's experience effects choice may be displayed as a list of stains calculated by the embodiment to approximate the client's desired experience 729. A listing of a best source or sources for the recommended strain or strains may also be provided to assist in clients obtaining the highest quality experience 731.

Much research has been done on the use of cannabis to treat medical conditions with cannabis showing great effect in the treatment and even towards the cure of a great plurality. Some illnesses may be minor enough to be considered ailments for which over-the-counter level diagnosis and remedy purchase is safe and effective. For this purpose, an embodiment may also include a choice 720 that allows clients to receive strain recommendations for minor ailments after presentation of a disclaimer that the embodiment is specifically aimed at recreational use, that chronic affliction, even with the seemingly minor symptoms listed may point to serious disease and that while none of the recommendations present the client with danger, health related cannabis use is a much more serious matter than recreational use. As disclosed, the screen layout of this figure is presented to make specific interface points about a possible method of organizing and gathering client information and is not meant to be a complete disclosure of all aspects that may be deemed necessary by those skilled in the art, thus these illustrations do not reflect a full set of capabilities nor to disclose possible limitations of embodiments of the invention.

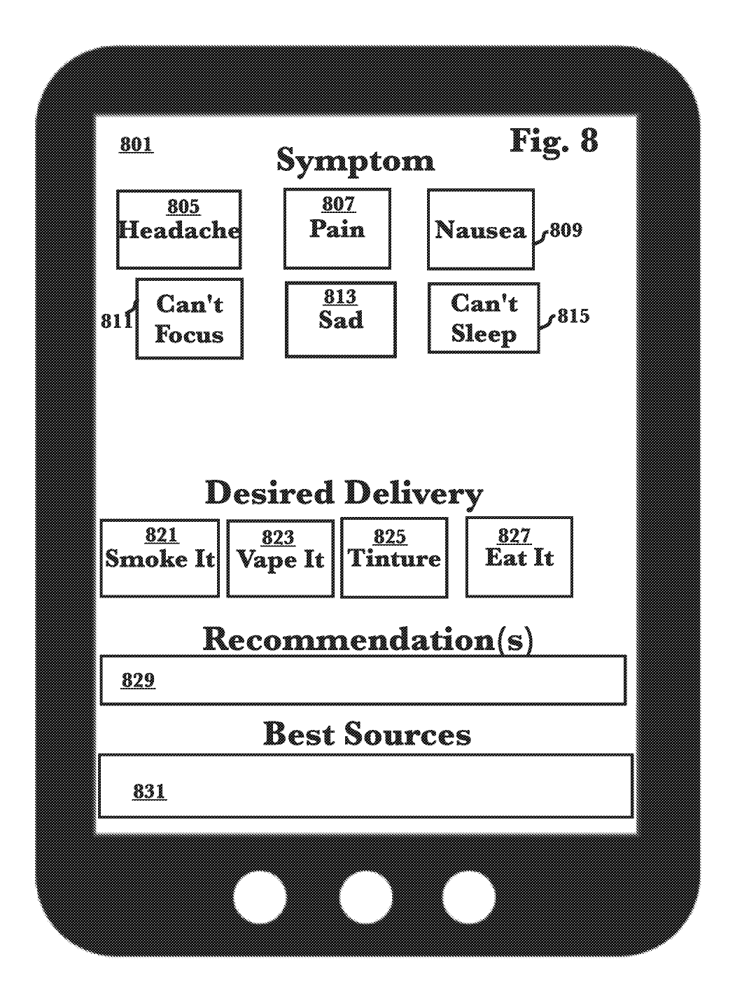

FIG. 8 is a second simplified screen capture of a recreational customer cannabis choice input screen various embodiments of the invention. According to some aspects, upon selecting a specific illness related choice 720, clients may be presented with a secondary screen, again drawn to represent a possible presentation on a client's tablet device 801, although smartphone and laptop/desktop versions of the same interface may be available (not drawn), presenting choices of more common medical ailments for which various herbal or over the counter remedy choices are already offered such as but not limited to “Headache” 805, general “Pain” 807, “Nausea” 809, difficulty focusing 811, mood disruptions 813 and insomnia 815, all of these ailments for which specific cannabinoids or sets of cannabinoids have been found efficacious as remedies. Again, after selecting one or more ailments from the top of the screen, and after programmatic computation by the analytic unit of the embodiment which may also account for feedback entered by the client concerning desired method of delivery 821, 823, 825, 827 and previous cannabis experiences with one or more strains, recommended strain or strains of cannabis, methods of delivery 829 and potential best suppliers 831 may be displayed. As previously disclosed the interface illustrated here was included to illustrate a pre-designated set of information, not as a complete working interface reflecting the capabilities or limitations of embodiments of the invention and thus should not be construed to display such.

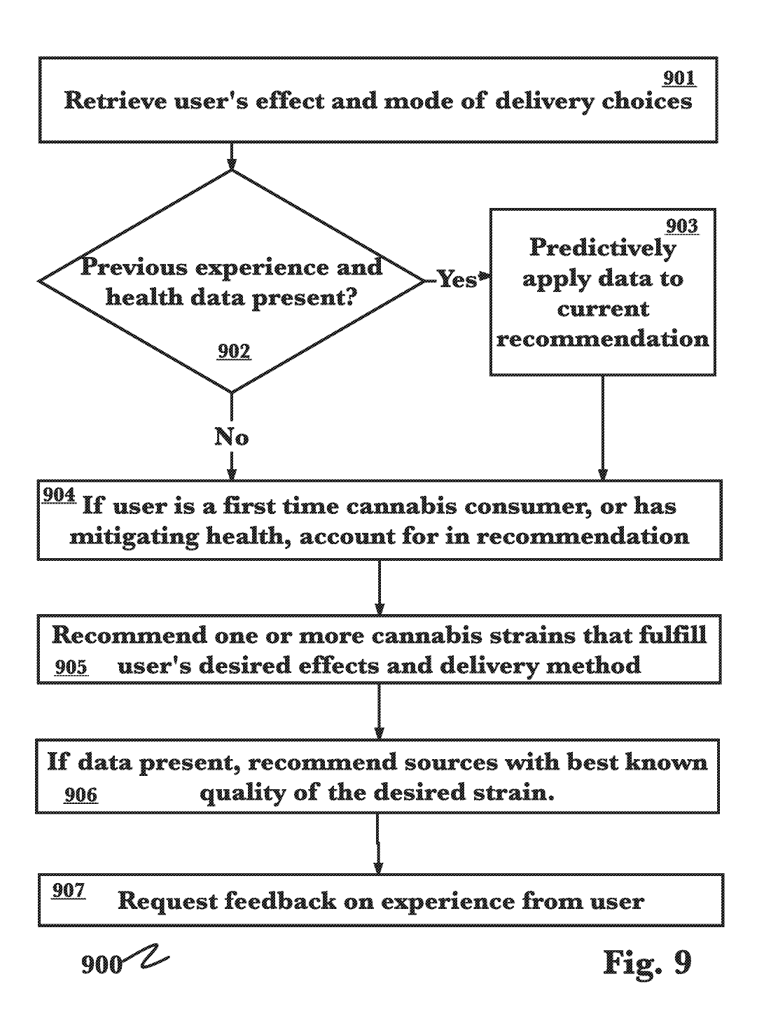

FIG. 9 is a flow diagram of steps taken by an aspect of the invention to convert a client's input into a cannabis strain and mode of delivery recommendations 900. After a client's selection of recreational cannabis experience parameters which may include both the desired effects of cannabis usage and a preferred delivery method 901 an embodiment may also employ available client's previous experience and health perception data which may include, but not be limited to sensitivity to other medications, mood, and energy level 902 to assist in making a more accurate predictive cannabis strain recommendation 903. The client may be a first time user of the embodiment and a first time recreational cannabis user in which case that status as well as the effects on any available health information 904 as part of the analytic computations that lead to a cannabis strain recommendation 905. Embodiments may also use available active compound analysis of strains from different suppliers, which have been found to differ somewhat in the past, to include source recommendations for recommended strains 906. Last, with the client recommendation, embodiments may also request that the client report back on the experience with the recommended strain and source to aid both the individual client in question and possibly assist in the training of the embodiment to create more accurate recommendations 907.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

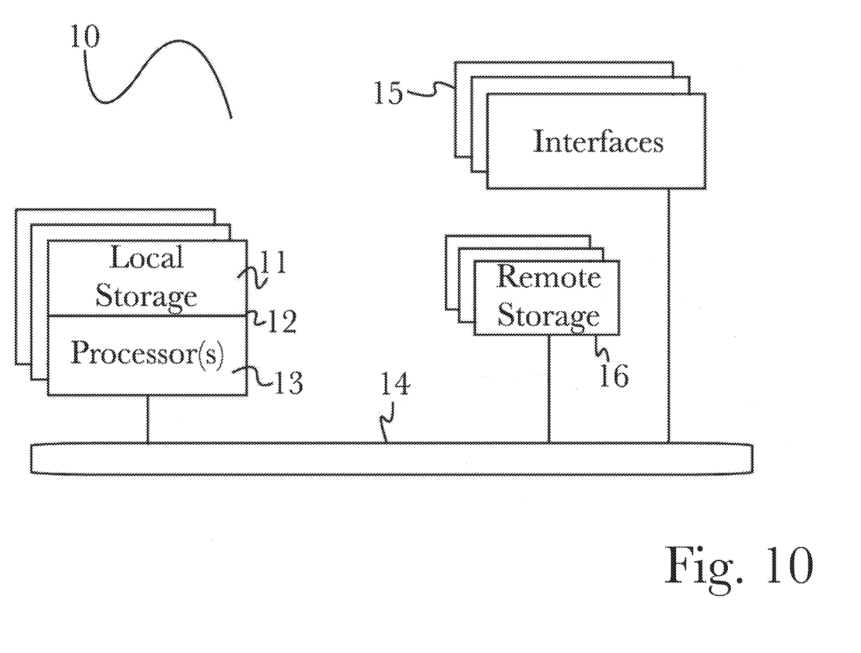

Referring now to FIG. 10, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10.

In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

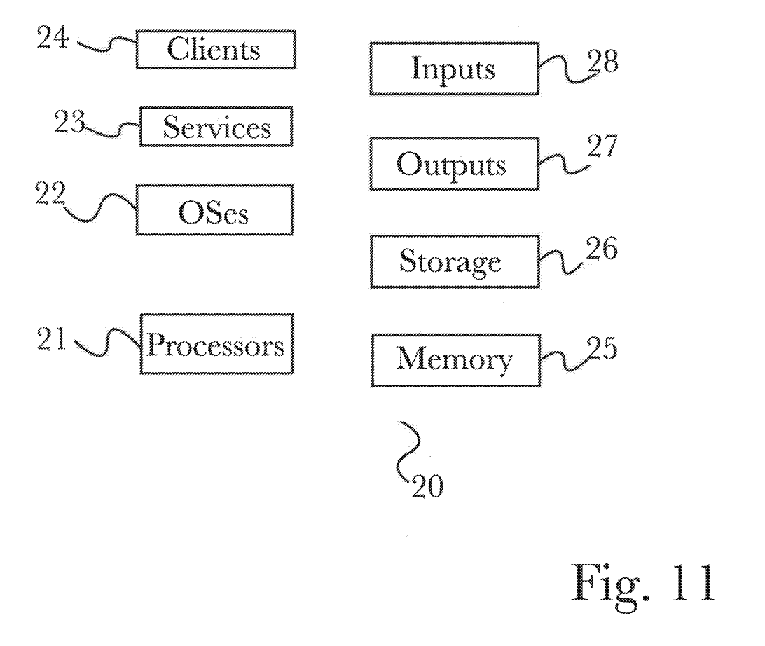

In some embodiments, systems according to the present invention may be implemented on a standalone computing system. Referring now to FIG. 11, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 10). Examples of storage devices 26 include flash memory, magnetic hard drive, CD-ROM, and/or the like.

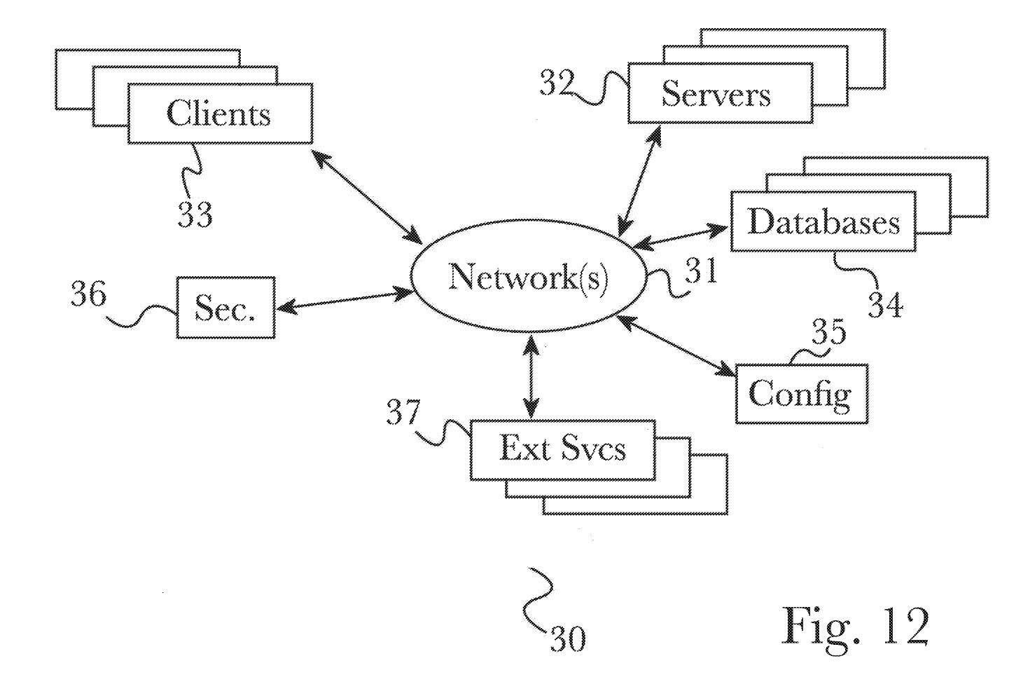

In some embodiments, systems of the present invention may be implemented on a distributed computing network, such as one having any number of clients and/or servers. Referring now to FIG. 12, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 9. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

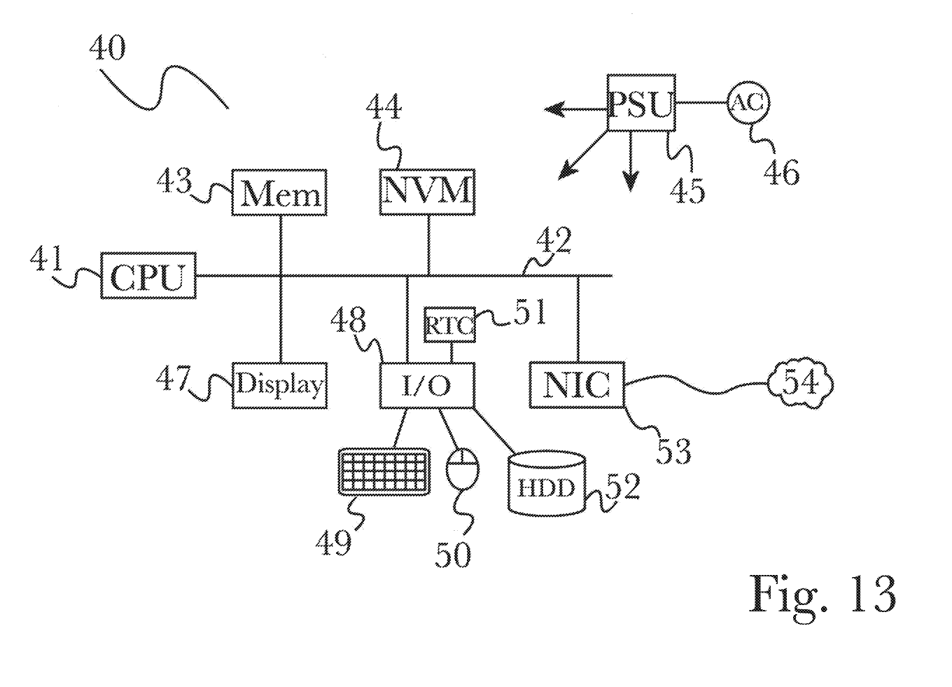

FIG. 13 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

1. A system for predictive recreational cannabis strain recommendation comprising:
an input portal comprising at least a processor, a memory, and a plurality of programming instructions stored in the memory and operating on the processor, wherein the programming instructions, when operating on the processor, cause the processor to:
present a plurality of interactive prompts to a number of client devices via a network;
receive cannabis use experience feedback from at least a portion of the client devices via user interaction with at least one of the plurality of interactive prompts;
normalize at least a portion of the cannabis use experience feedback for predictive analytics computation;
retrieve results of scientifically controlled cannabis strain analysis and normalize at least a portion of the results for predictive analytics computation;
receive requests comprising at least one effect desired by the user of at least one of the client devices for a future cannabis experience and normalize at least a portion of the requests for predictive analytics computation;
an experience analytics module comprising at least a processor, a memory, and a plurality of programming instructions stored in the memory and operating on the processor, wherein the programming instructions, when operating on the processor, cause the processor to:
retrieve normalized client supplied cannabis use experience feedback data;
retrieve normalized scientifically controlled cannabis strain analysis data;
receive normalized request comprising at least one cannabis effect desired by the client for a future cannabis experience;
retrieve normalized data that attributes physiological effects to known active cannabis resident compounds;
programmatically calculate effect rating scores for cannabis strains based at least in part upon the analysis determined active cannabis resident compound levels and known effects of active cannabis resident compounds;
programmatically determine at least one cannabis strain from at least one legal cannabis source that closely matches client's normalized request and accounts for at least the user of at least one of the client devices previous use experience feedback data using predictive inference functions engineered for recreational cannabis trade; and
a recommended product choices display comprising at least a processor, a memory, and a plurality of programming instructions stored in the memory and operating on the processor, wherein the programming instructions, when operating on the processor, cause the processor to:
output at least one recommended recreational cannabis strain that closely matches clients' normalized requests in a format best suited for this task.

2. A method for predictive recreational cannabis strain recommendation comprising the steps of:
a) receiving cannabis use experience feedback from a number of client devices via user interaction with at least one of a plurality of interactive prompts and normalizing at least a portion of the cannabis use experience feedback for predictive analytic computation using an input portal stored in a memory of and operating on a processor of a computing device;
b) retrieving results of scientifically controlled cannabis strain analysis and normalizing at least a portion of the results for predictive analytics computation using the input portal;
c) receiving requests comprising at least one effect desired by the user of at least one of the client devices for a future cannabis experience and normalize at least a portion of the requests for predictive analytics computation using the input portal;
d) retrieving normalized data that assigns physiological effects to known active cannabis resident compounds using an experience analytics module stored in a memory of and operating on a processor of a computing device;
e) calculating effect rating scores for cannabis strains based at least in part upon the analysis determined active cannabis resident compound levels and at least in part upon known effects of active cannabis resident compounds using the experience analytics module;
f) determining at least one cannabis strain from at least one legal cannabis source that closely matches client's normalized request and accounts for at least the user of at least one of the client devices previous use experience feedback data employing predictive inference functions engineered for recreational cannabis trade using the experience analytics module;
g) outputting at least one recommended recreational cannabis strain that closely matches clients' normalized requests in a format best suited to convey this information using a recommended product choices display stored in a memory of and operating on a processor of a computing device.
